(19) United States
(12) Patent Application Publication
(10) Pub. No.: US 2026/0203661 A1
(43) Pub. Date: Jul. 16, 2026

(54) OPTIMIZED PROCESSING OF COMPLEX DATA SETS VIA NOVEL MACHINE LEARNING BASED SOLUTIONS

(71) Applicant: ITALENT CORPORATION, Campbell, CA (US)

(72) Inventors: Rafal Wojcik, Warsaw (PL); Wojciech Matula, Krakow (PL); Daria Puchalska, Lodz (PL); Oskar Jarczyk, Warsaw (PL); Filip Twardy, Krakow (PL); Filip Gurgul, Krakow (PL); Maciej Kauf, Krakow (PL)

(21) Appl. No.: 19/446,030

(22) Filed: Jan. 12, 2026

Related U.S. Application Data
(60) Provisional application No. 63/745,223, filed on Jan. 14, 2025.

(51) Int. Cl. G06N 20/00

(52) U.S. Cl. CPC G06N 20/00

(57) ABSTRACT

A system and method are provided for processing complex, heterogeneous data sets within an aggregated data processing environment. Changes to stored information are detected, encoded into standardized internal messages, and transformed as needed into API-compatible formats for disparate client systems based on mappings between standard and client-specific data types. A Data Engine further trains machine learning models to evaluate relationships between first-category and second-category information by identifying whether new records correspond to preexisting data, labeling and aggregating multiple records into updated representations, and encoding the aggregated representations and associated data into a shared embedding space for model training. Training data may be supplemented using outputs from generative language models, and model performance is iteratively assessed using ranking and classification metrics, error-focused resampling, and automated bias testing, with training criteria updated based on evaluation results.

### CROSS REFERENCE TO RELATED APPLICATIONS

This application claims priority to U.S. Provisional Application No. 63/745,223 filed on January 14, 2025, titled “Optimized Processing of Complex Data Sets Via Novel Machine Learning Based Solutions,” the disclosure of which is incorporated herein by reference in its entirety as though set forth in full.

### BACKGROUND

The collection and processing of large and complex data sets by data aggregators presents unique problems, for example, in understanding and normalizing disparately formatted data sources, limiting the amount of data that has to be stored for later processing, and limiting the types of data that must be stored (e.g., sensitive, confidential, health, financial, etc.) for later processing. These and related issues may substantially increase usage of computing and power supply resources and slow response time for users. One such data set affected by these problems is hiring information such as candidate and job data.

Solving the candidate to job matching problem with machine learning models provides a substantial challenge in terms of techniques that can be used to efficiently train state-of-the-art models on this task. Challenges include a lack of training data and difficulty of labeling new data points, formulating the training task as an objective that can be taught to the model, a lack of established training procedures for successfully training the models, a lack of state-of-the-art Deep Learning models capable of processing entire documents without limitations to the input length, and in an efficient way, finding appropriate metrics which best reflect quality of the model on the matching task, reducing the risk of training model bias, and many more. Some specific features of the holistic candidate search require solving problems outside of the scope of recommendation algorithms.

When faced with such complex data sets, there are substantial roadblocks to effectively translating human text inputs into a set of instructions. For example, when classical machine-learning based solutions are used to control filtering and matching mechanisms, challenges may be encountered, such as jail-breaking by providing malicious content, or producing incorrect results (e.g., “hallucinations” and similar phenomena). This can cause a user to lose confidence in the data sources and analysis tools employed to understand underlying data. Further, user interface methodologies for analyzing such data may be cumbersome and complex, requiring excessive space within a GUI or creating GUI overload that prevents users from taking full advantage of available analysis tools.

### SUMMARY

According to an example embodiment, a method of synchronizing complex data sets over disparate domains includes identifying a change of information at an aggregated data processing system. The method further includes creating a message representing the change of information in a standardized format of the aggregated data processing system. A plurality of unique client system types to receive the change of information are identified. For each unique client system type, the method determines whether a standard data type of the change of information corresponds to a respective client system data type of the unique client system type. For each unique client system type where the standard data type matches the respective client system data type, a message is created that is compatible with a respective API service of the unique client system.

In another example embodiment, a method of training a complex data aggregation system includes receiving information associating first data for a first category of information data with second data of a second category of information. The method determines whether the second data corresponds to preexisting data within the second category of information. Data records within the second data are labeled based on the second data not corresponding to the preexisting data. Based on the labeling of the second data, additional preexisting data is created based on multiple records of the second data. A machine learning model is trained to evaluate data of the first category versus the additional preexisting data.

In another example embodiment, a method of training a machine learning model within an aggregated data processing system includes receiving information associating first data for a first category of information with second data for a second category of information. The method determines whether the second data corresponds to preexisting data within the second category of information stored in an aggregated data repository. A plurality of records within the second data are labeled based on the second data not corresponding to the preexisting data. An updated representation for the second category of information comprising aggregated data derived from multiple records of the second data is generated from the labeled plurality of records. The machine learning model is trained using the aggregated data and the first data by encoding the aggregated data and the first data into a shared embedding representation and updating parameters of the machine learning model based on comparisons between the embedding representations.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an Applicant Tracking System (ATS) write system in accordance with an embodiment of the present disclosure;

FIG. 2 shows exemplary steps associated with a write process for the ATS write system shown in FIG. 1 in accordance with an embodiment of the present disclosure;

FIG. 3 shows an ATS read system in accordance with an embodiment of the present disclosure;

FIG. 4 shows exemplary steps associated with a read process for the ATS read system shown in FIG. 3 in accordance with an embodiment of the present disclosure;

FIGS. 5A-5C show exemplary steps of a process flow for a data matching engine in accordance with an embodiment of the present disclosure; and

FIG. 6 shows a schematic skills-to-career mapping system based on skill embeddings and skills voting, in accordance with an embodiment of the present disclosure.

### DESCRIPTION

In accordance with the present disclosure, a variety of tools are provided to improve the intake, distribution, processing, training, inference, and display of complex aggregated data sets. The operations described in the present disclosure provide substantial advantages over existing processing systems, for example, by reducing the amount of data that must be stored for these operations, reducing processing steps and processing time for these operations, and providing for enhanced and simplified GUIs and user interfaces that facilitate full use of powerful processing functionality through simplified series of user interactions. Accordingly, the operations described in the present disclosure decrease usage of memory space and processor operations (e.g., CPU, GPU, TPU, etc.), resulting in substantial improvements to the underlying combined hardware / software systems, reduced power consumption, reduced occurrence of errors, and improved and simplified GUIs and other user interfaces. For example, the disclosed systems can reduce GPU memory footprint by minimizing redundant model instances, improve cache locality within the underlying hardware, and decrease latency of data transfer between storage and compute components, thereby improving overall throughput of the computing platform itself rather than merely automating a hiring workflow.

These improvements are achieved through several novel machine-learning based systems introduced in the present disclosure, each solving separate tasks related to candidate and job processing. The first instance of the systems, called further Data Engine, provides a solution to the problem of recommending the best candidates for job offers with use of state-of-the-art Deep Learning (DL) models. The Data Engine in essence is a continuous improvement framework, which allows safe, fast, repeatable and very effective training of the Deep Learning models on best candidate retrieval task. The advantage of this framework over other solutions has several layers, as the system introduces a novel approach to how the process of recommending best candidates to job offers can be formulated as a machine learning based task.

Example advantages include strategies that allow: precise control of the model’s knowledge; minimizing the amount of data necessary for training; structuring and optimizing the labeling process to be fast and bias-free; and performing efficient error-analysis. Additionally, the framework introduces: a novel Contrastive Loss Function, training and pre-training procedures adapted for a matching task, a set of evaluation metrics best suited for two-fold nature of candidate recommendation, and novel Transformer model architectures, which allow digesting arbitrary long input sequences. Additionally, the framework includes automated bias testing to control unwanted bias in the model.

Moreover, machine learning based systems introduced in the disclosure include novel use-cases of Generative Large Language Models (LLMs), which form interactive user interfaces that allow for dynamically changing responses of the candidate retrieval system, and parsing user prompts written in natural language into code understandable by the system. Additionally, the system introduced in the present disclosure includes a novel algorithm that utilizes machine learning models to recommend the best career paths for candidates.

In an example embodiment of the present disclosure, the complex data aggregation will be described in the context of systems for managing and tracking of job applicants and/or employees. The overall infrastructure for such systems is extremely complex and fragmented, with a variety of data services and sources performing different functions such as job search platforms or web sites (e.g., Indeed, LinkedIn, etc.), employer and recruiter facing programs such as Applicant Tracking System (ATS) programs, and internal employer HR management software. Each of these programs, systems, or websites may provide data in various formats (e.g., raw, extracted, structured, unstructured) accessible by different methods and APIs.

The disclosed system provides the ability to process only the differential data between the ATS and the disclosed system using a simplified, unified format. By reducing the workload per task, threads complete cycles faster, allowing the system to handle higher volumes with fewer threads and fewer CPU cycles spent on synchronization. Additionally, this makes the synchronization recovery process highly efficient; during an auto-resync or error retry, the system avoids “full-state” re-parsing and only fetches the missing Delta, preventing the CPU and I/O spikes. The unified internal message representation of the disclosed systems also reduces the number of format conversions and associated serialization and deserialization operations typically required between disparate ATS and HR systems, thereby reducing CPU cycles spent on parsing and reformatting data.

As an example, ATS systems help companies manage large volumes of job applications by organizing, tracking, and filtering applicant information. For example, ATS systems can automatically scan and parse resumes and attempt to identify qualified candidates based on keywords, skills, experience, and education. However, these traditional “word matching” technologies rely on postings and applicants using the same lexicography, create a significant risk of gaming the system by matching keywords, and may overlook qualified candidates who describe concepts differently or do not game the system. ATS systems also facilitate employers’ management of multiple job boards from a single interface, provide tracking of the status of applicants throughout the hiring process, and collaboration with team members by sharing feedback. Again, however, these traditional ATS systems only work as well as the underlying data that is provided from a variety of disparate systems and the corresponding key-word matching processes used at the ATS. Further, traditional ATS systems have been coded and built over a long period of years, and thus rely upon underlying software, databases, and methodologies that are old and deprecated, such that they lack useful or effective mechanisms for document intelligence and document parsing operations. The technology described herein addresses these technical shortcomings by introducing improved parsing and embedding-based matching that operate efficiently over heterogeneous document formats.

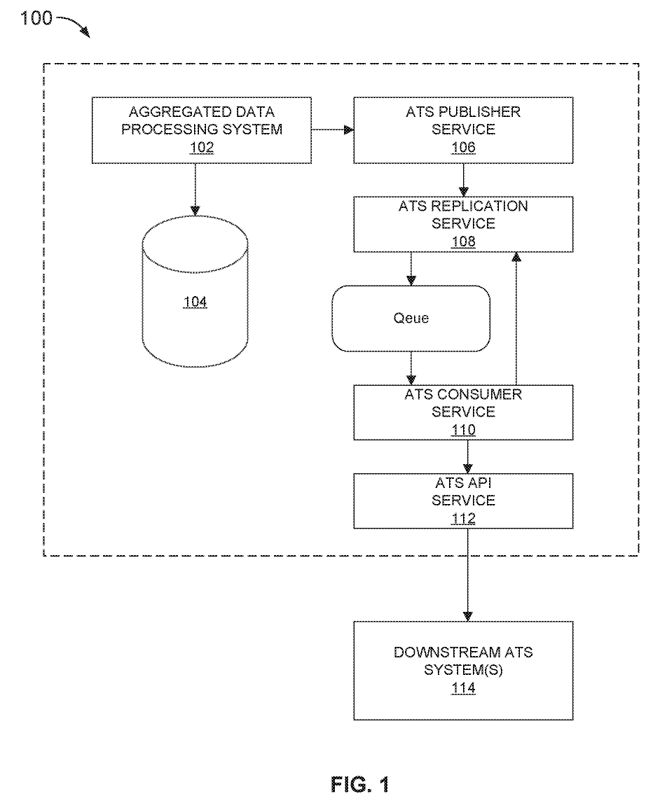

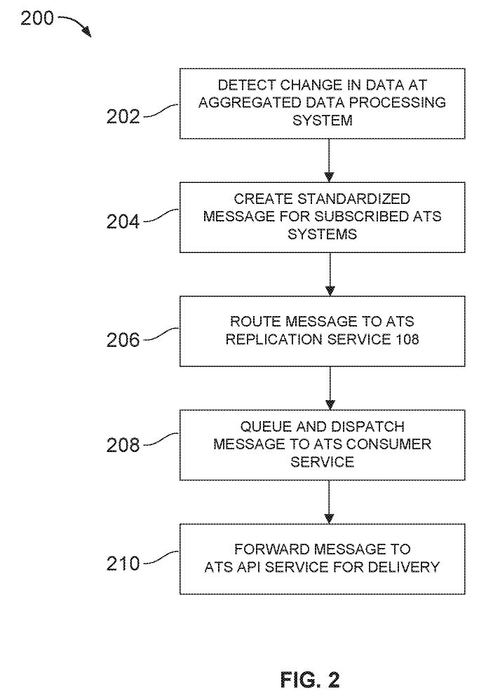

One issue faced by ATS systems is the accessing and synchronization of data to and from disparate systems. An example embodiment of disparate data system synchronization is depicted in FIGS. 1-2. FIG. 1 depicts an ATS write system 100 and FIG. 2 depicts steps of an ATS write process using ATS write system 100 in accordance with the present disclosure. Although particular steps are depicted in a particular order in FIGS. 1-2, it will be understood that additional steps may be added, steps may be removed, and the order of steps may be modified in certain embodiments.

As seen in FIG. 1, ATS write system 100 may include an aggregated data processing system 102, a centralized database 104, an ATS publisher service 106, an ATS replication service 108, an ATS consumer service 110, and an ATS API service 112, all of which may operate together to prepare and transmit updates to downstream ATS systems 114. The aggregated data processing system 102 may interface with any of multiple ATS services that may be resident at an entity (e.g., workday, HCM, smartrecruiters, etc.) as discussed below. The aggregated data processing system 102 may monitor information from a variety of sources (e.g., job websites, ATS systems, third-party data sources, historical records, etc.) to maintain aggregated information about candidates, positions, and activity and history of candidates and positions. The aggregated data processing system 102 may maintain a status of the information available at each ATS system serviced by the aggregated data processing system as well as settings for timing of when to provide updates to a particular ATS system. When there is candidate information (e.g., his/her history, position information, or other information) to be updated to an ATS system 114, the ATS Write operations depicted in FIG. 2 are performed. The interaction of these components is configured to reuse a shared standardized message structure, thereby reducing memory requirements in the centralized database 104.

The aggregated data processing system 102 may be in communication with the centralized database 104 that stores information aggregated from multiple sources and to be provided to ATS systems 114 in accordance with respective settings and requirements from each system or entity (e.g., a single company with multiple ATS systems). Certain data may be aggregated and available to multiple ATS systems depending on their settings or requirements, while other data may be “sandboxed” for particular ATS systems, such as feedback and information for a particular entity. Data that is in aggregated form may be useful for limiting the overall need for storage and duplication of records and for providing a single source of truth (e.g., for a candidate) that is up to date from multiple information sources.

With additional reference to FIG. 2, at step 202 aggregated data processing system 102 detects a change in data stored in database 104. When there is a change in status (e.g., underlying information) for a user (e.g., a candidate or employer), the aggregated data processing system 102 may instantiate the ATS publisher service 106 that automatically creates a message at step 204 to be sent to each ATS system 114 that is subscribed to the user. This initial message is formatted in a standard format resident at the aggregated data processing system (e.g., that is not particularized for any ATS system data formats). By generating the standardized message once and reusing it across multiple downstream transformations, the system can avoid repeated format conversions.

The new message to be distributed to the various ATS systems may then be routed to ATS replication service 108 at step 206, which loops with a message queue and ATS consumer service 110 at step 208. When a message successfully maps to an entity at the ATS system 114, the message is forwarded from the ATS consumer service 110 to the ATS API service 112 at step 210. Collectively, this loop may manage and queue messages to a particular ATS system 114, providing an exponential backoff delay for subsequent send attempts to allow the system, including the message queue and/or communication channels, to heal from any errors or failures in communicating with the ATS system 114. To avoid message queue overload, system 100 may use throttling on the message dispatching side in the ATS consumer service and ATS replication service processes. A backpressure mechanism can be utilized to prevent overloading communication channels (e.g., at APIs). This coordinated message queuing and backoff behavior reduces the likelihood of queue saturation and connection thrashing, thereby improving reliability and stability of the underlying networked computing environment.

The ATS API service 112 may interface with the various APIs available at each ATS system 114, and via those APIs, to the specific settings of each employer/user of the ATS system 114. In this manner, each data item to be written to (or made accessible to) a particular ATS system 114 (e.g., to a local ATS system or a cloud ATS system accessible by the user) is maintained as a single “unified” data field at the aggregated data processing system 102 (e.g., a single source of “truth” with respect to the ATS user) and is “translated” or modified as necessary and provided to the particular ATS system 114 in accordance with the requirements of that ATS’s particular API calls. The actual updates may be performed via a proxy service responsible for communication with the ATS systems 114 in accordance with rate limits for data transmission, which avoids overloading the ATS system(s) 114 or communications channels with those systems 114. By centralizing the translation logic and enforcing rate limits at the proxy service level, the system decreases redundant per-ATS integration code, reduces API call bursts, and improves the efficiency of network utilization compared to conventional ATS integration solutions.

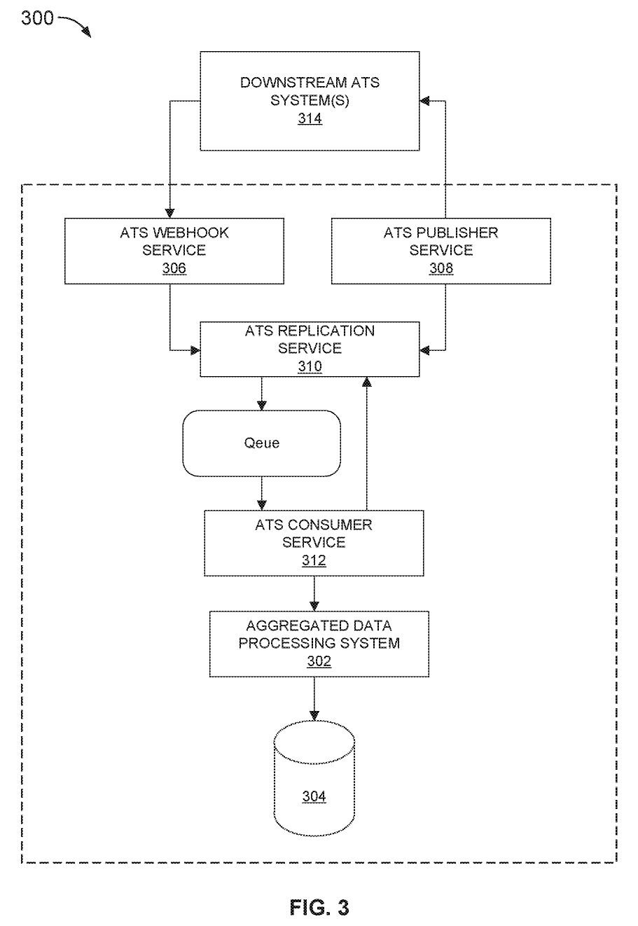

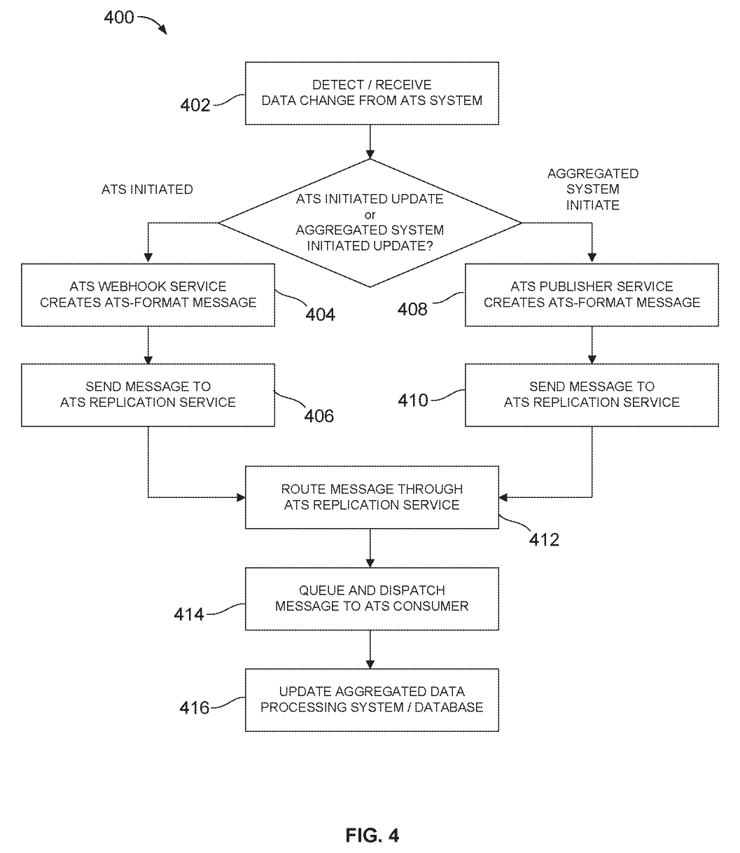

FIG. 3 shows an ATS read system 300 and FIG. 4 depicts steps of an ATS read process 400 using ATS read system 300 in accordance with the present disclosure. As seen in FIG. 3, ATS read system 300 may include an aggregated data processing system 302, a centralized database 304, an ATS webhook service 306, an ATS publisher service 308, an ATS replication service 310, and an ATS consumer service 312, all of which operate together to receive and process updates from ATS systems 314. With additional reference to FIG. 4, at step 402 the aggregated data processing system 302 may detect or receive a change in data from ATS system 314. A data update to the aggregated data processing system 302 may be initiated by the ATS system 314 actively transmitting updates to the aggregated data processing system 302, responding to read requests from the aggregated data processing system 302, or combinations thereof (e.g., based on settings or data priorities).

In the instance that a data update is initiated from the ATS system 314 (i.e.,ATS writes to the aggregated data processing system), the underlying data to be updated and any associated information (e.g., field identifiers or other headers, settings, etc.) may be provided to the ATS webhook service 306 that creates the message to be sent in accordance with a message format for the particular ATS system 314 at step 404. The message may then be sent to the ATS replication service 310 of the aggregated data processing system 302 at step 406.

In the instance that a data update is initiated by the aggregated data processing system 302 (i.e., aggregated system reads from ATS), the underlying data to be updated and any associated information (e.g., field identifiers or other headers, settings, etc.) may be provided to the ATS publisher service 308 that creates the message to be sent in accordance with a message format for the particular ATS system 314 at step 408. The message may then be sent to the ATS replication service 310 of the aggregated data processing system 302 at step 410. The use of distinct webhook and publisher services for push- versus pull-initiated updates enables more efficient use of network and compute resources by tailoring buffering and retry behavior to the characteristics of each communication pattern.

The new message from the ATS system 314 to be provided to the aggregated data processing system 302 may then be routed to ATS replication service 310 at step 412, which loops with a message queue and an ATS consumer service 312 at step 414. When a message successfully maps to an entity at the aggregated data processing system 302, the message may be forwarded from the ATS consumer service 312 to the aggregated data processing system 302 at step 416. Collectively, this loop may manage and queue messages to a particular ATS system 314, providing an exponential backoff delay for subsequent send attempts to allow the system, including the message queue and/or communication channels, to heal from any errors or failures in communicating with the ATS system 314. To avoid message queue overload, the system may use throttling on the message dispatching side in the ATS publisher service 308 and the ATS replication service 310 processes. A backpressure mechanism can be utilized to prevent overloading communication channels (e.g., at APIs). Because the read-side pipeline reuses the same backoff and backpressure mechanisms as the write-side pipeline, the overall system exhibits improved stability under load and lowers the probability of dropped messages or stalled queues, which improves the operation of the distributed computing environment.

In another example, a matching Data Engine may be utilized to provide for streamlining of the process of training artificial intelligence models to perform complex matching between candidates (e.g., a first category of information) and job postings (e.g., a second category of information). Once properly trained, the candidate matching may be performed by the trained Transformer-based DL model (which instances can include novel variations of architectures from “BERT: Pre-training of Deep Bidirectional Transformers for Language Understanding” by Devlin et al, and “RoBERTa: A Robustly Optimized BERT Pretraining Approach” by Liu et al, which work on entire text data without the limits to the input sequence length) by encoding job and candidate data into a complex, dense vector representation, that does not get overwhelmed by keyword matching, i.e., that ingests information about the candidate that can be extracted from a resume or other data source, including tone, “soft” skills, interdisciplinary skills, personality type, and the like. Efficiency of Transformer-based models on encoding complex lexical information is a well-established fact in Natural Language Processing field, and as such can be thought of self-explanatory. Further, the trained model can deliver specialized, differentiated results based on user input received by the employer which may be delivered via filters and/or commands, such as “provide me results with an increased weighting towards [teamwork/programming skills/attention to detail, etc].” The Data Engine can deploy these Transformer models in a way that reuses a single shared embedding space for both jobs and candidates.

As an example, for candidate recommendation, custom Transformer-based models (Deep Learning Models) may be used. The custom Transformer-based models can be trained with a custom version of a contrastive loss function, and a custom training-scheme, run using a custom training framework built in PyTorch, for example. The models may be used to encode text data into dense, n-dimensional space (e.g., 512 or 768 dimensions), and then retrieve the most relevant candidates from the database by comparing (e.g., via cosine similarity) candidate embeddings and job embeddings. By using Transformer-based models, and with the models encoding texts of candidates into a dense embedding space, the system can represent not only the presence of keywords, but also contextual information, like tone, industry, different types of skills, etc.

One example matching process includes retrieval of the most relevant candidates (e.g., top 500) from a Redis vector database by comparing (e.g., by cosine similarity) job and candidate embeddings. The database can be pre-populated using AI matching models (e.g., Transformer-based models, described above) and stored in Redis vector database for efficient processing. For efficiency purposes, in some embodiments, a matching process can also include first-stage retrieval with a BM25 algorithm to identify preferred candidates (e.g., top 500 best matching candidates), who are then re-ranked with use of aforementioned Transformer-based AI matching models. Finally, the matching process can also include combination of similarities of embeddings calculated based on several different modalities of information, i.e., full raw text, just the job title, combination of skills detected in the documents, etc. In such a setup, final matching score is the mean score of similarities from each modality. All these approaches serve either faster compute time, or higher quality of final recommendations by combining selected information from isolated parts of original documents.

In accordance with the present disclosure, a matching problem can be conceptualized as a job-level teaching task, with a breakdown of teaching the matching task to the machine learning models into a step-by-step process, straightforward to implement and continuously repeat in an efficient manner. The matching Data Engine may include strategies for handling new and already trained jobs and mapping them to each other. This may avoid unnecessary training and provide optimal strategies for sampling new observations to be labeled and trained on. In some instances, this may be the fastest way to improve the recommendations for the users, while also controlling what the model knows. A repeatable and coherent labeling process may be implemented, along with strategies for checking training data quality and improving it with generative LLM models if necessary. Further, a new data sampling, training, and evaluation loop may be executed until desired quality score is reached, along with a training objective which joins the task of ranking best candidates first and assigning the correct badge to candidates. The system may also include appropriate evaluation metrics for the model and a bias test after each iteration of the model’s improvement. By formalizing matching as a job-level teaching task with explicit sampling and labeling policies, the system reduces the amount of labeled data required to achieve a target model performance, which lowers storage requirements for training datasets and shortens training cycles on the underlying hardware.

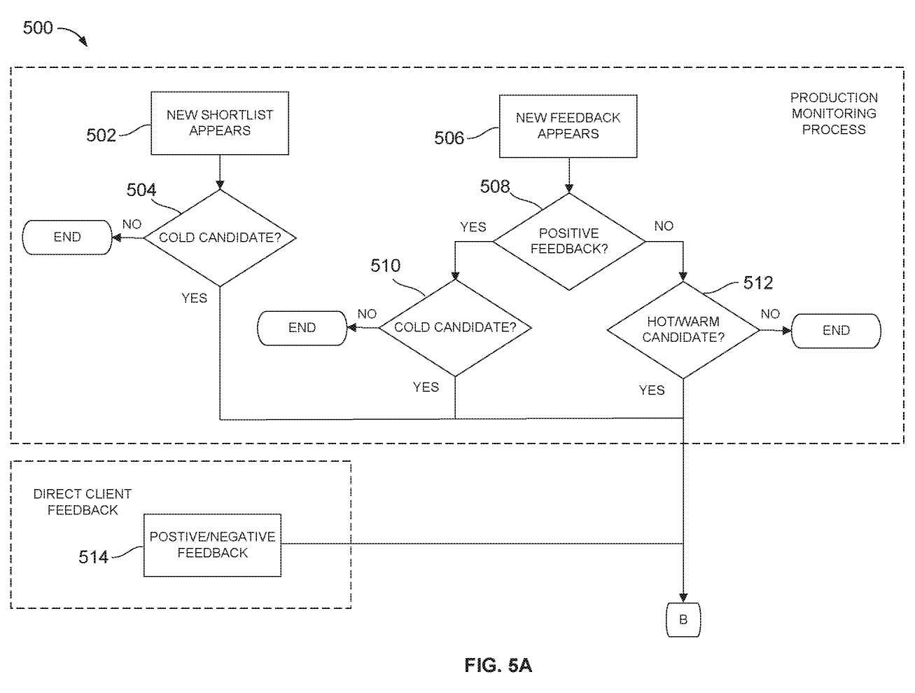

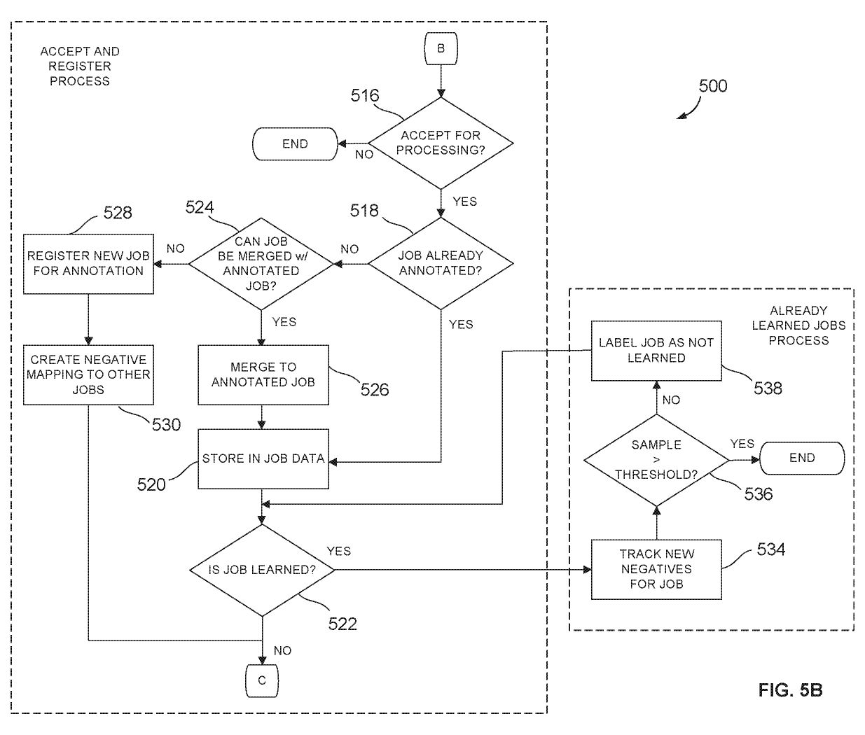

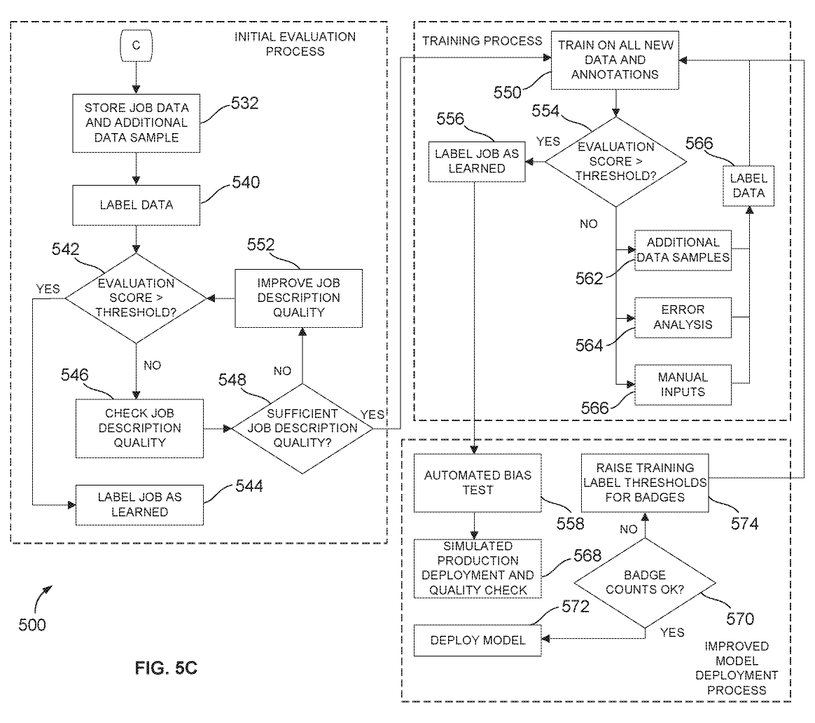

An example process flow for the data matching engine is depicted in FIGS. 5A-C. Although particular steps are depicted in a particular order in FIGS. 5A-C, it will be understood that additional steps may be added, steps may be removed, and the order of steps may be modified in certain embodiments. In FIGS. 5A-5C, these operations collectively define a matching process 500.

Referring to FIG. 5A, information about candidates is accessed from a data source such as a production monitoring tool (Production Monitoring Process) or direct feedback from clients (e.g., via email or electronic form) (Direct Client Feedback) with information about a candidate at step 502. In this manner, actual evaluation results are used to seed the learning algorithms and, at step 504, the system may evaluate whether a newly shortlisted candidate should be treated as a cold (negative) signal. If the newly shortlisted candidate should be treated as a cold (negative) signal, processing continues to step 516 (discussed below), and if not, the processing ends.

In some instances, the aggregated data processing system may utilize (e.g., with client permission) aggregated information from multiple clients or entities, providing enhanced results and larger data sets for purposes of model training. Feedback may be provided in the context of a “shortlist” (user activity in the system, so decisions to shortlist/interview/hire a candidate), specific feedback on candidates for a position, and/or direct client feedback on the candidate/position match, with each result scored based on a rating, such as a numeric ranking, a hot/cold indicator, and/or other specific structured or unstructured information. The system may also determine at step 506 whether new direct feedback has been received for a candidate, and at step 508 whether such feedback should be interpreted as a positive-signal label (e.g., hot or warm). In some embodiments, and optionally, sources of information may be normalized or represented by a combined score or multi-dimensional vector, resulting in normalized identifiers and scores for further processing. If feedback is positive for a candidate that has previously been treated as a cold signal, process 500 continues to step 510. If the new feedback is negative for a candidate that has previously been treated as a hot or warm signal, process 500 continues to step 512. In other cases, the process ends, as model recommendations are on par with the feedback.

At step 510 the system may evaluate whether the newly shortlisted candidate should be treated as a cold (negative) signal. If the newly shortlisted candidate should still be treated as a cold (negative) signal, processing continues to step 516 (discussed below), and if not, the processing ends. At step 512 the system may evaluate whether, in view of the prior hot or warm treatment and the newly received negative feedback, the newly shortlisted candidate should continue to be treated as a hot/warm (positive) signal. If the newly shortlisted candidate should be treated as a hot/warm (positive) signal, processing continues to step 516 (discussed below), and if not, the processing ends. Step 514 depicts instances where the feedback is directly received from a client. At this step positive/negative feedback is collected and the process then proceeds to step 516.

Referring to FIG. 5B, a new record is processed by the Accept and Register Process at step 516. For example, as an initial step, checks may be performed on the data record to be processed such as to confirm data integrity or formatting that is suitable for further processing. If this initial “accept for processing” step is successfully completed, processing continues to determine at step 518 if the position has already been annotated by the system. If the position has already been annotated, new data is stored for the job at step 520 and processing continues to step 522 which determines if the job was learned (discussed further below). This process prevents malformed or redundant records from entering the training pipelines, thereby lowering unnecessary disk writes and avoiding wasted compute cycles that would otherwise be consumed processing invalid data.

If the position has not been annotated, processing continues to the merger determination step 524 where the new job record is compared against existing annotated jobs to determine whether a merge is appropriate. At the merger determination, it is determined whether the position being analyzed can be merged with a previously annotated position, for example, based on a scoring of a similarity between the position being analyzed and previously annotated positions. Similarity can be obtained with Transformer models trained on open-source datasets focused on Semantic Textual Similarity task, to allow efficient comparison of similarity between position names. If a match is found (i.e., it is determined that the position being analyzed can be merged with a previously annotated position), the process proceeds to step 526 where the position is updated to correspond to the previously annotated position (“merge to annotated job”), new data is stored for the job at step 520 (“store in job data”) and processing continues to step 522 (discussed further below).

If a match is not found at step 524, a new job is registered for annotation at step 528. Processing proceeds to step 530 where negative mappings are created between new job and other jobs already registered in the Data Engine. Negative mappings are created based on position similarity and are later on used in the training step to create more negative pairs for the training. Processing can then proceed to the step 532 shown in FIG. 5C.

Referring back to step 522, the system is queried as to whether the position has already been taught to the machine learning model with the Data Engine. If the job/position has not yet been learned, processing continues to step 532 shown in FIG. 5C for further processing. If the position was previously learned or was merged with a previously learned position, processing continues to the Already Learned Jobs Process at step 534. Within the Already Learned Jobs Process, there is a check performed at step 536 on how many new negative observations have been stored for the position, and if less than a threshold number of records (e.g., less than 10)have been processed for the position, the processing ends. If more than a threshold number of records have been processed for the position, processing continues to add the new data to be labeled and to mark the position as not learned at step 538, after which processing returns to step 522. This processing facilitates triggering re-learning of already learned jobs within the Data Engine once the threshold number of new records which indicate needs for improvement are collected. This conditional re-learning mechanism avoids retraining the model on every incremental update and instead performs targeted retraining only when meaningful changes have accumulated.

Referring to FIG. 5C, the Initial Evaluation Process is shown, which determines whether there is adequate data to mark a position as learned, and, as appropriate, supplements the data. As an initial step, candidate data for the position is accessed based on the newly acquired data (e.g., from FIGS. 5A-B) at step 532.

If an additional data sample is required to train the model properly on the job (i.e., the data from FIG. 5A are not enough observations), the Data Engine includes a set of functionalities that allow efficient data gathering, which allows collection of the most important data in the smallest data sample possible. Some of the strategies may include sampling from recommendations of the AI matching model itself for this job, and taking a balanced sample of hot, warm, and cold candidates to best represent model’s current knowledge about the job. The sample may also be based on other types of heuristics/strategies (e.g., active learning strategies like Uncertainty Sampling, or Diversity sampling, and/or using top recommendations from simpler unsupervised models like BM25) to diversify the sample. By focusing the sample on the most informative candidates, the system can achieve a desired model performance with fewer labeled examples, which decreases the total volume of training data that must be stored and processed.

The data is labeled at step 540. The final objective is to obtain the most diverse and informative sample of data to be labeled, so that the model is tested and trained on the most optimal data, and at the same time a small enough sample to speed up the labeling process and avoid unnecessary work. Additionally, the Data Engine provides a set of functionalities, which allow for structuring the labeling into a step-by-step process, and ensures that labels are coherent between candidates in order to minimize the bias that the recruiter inputs in the labeling procedure.

Functionalities may include definition of criteria that a candidate has to meet for the job, along with their weights, which indicate how important the criteria are in determining if the candidate is a good match for the job. The weights can be floating-point numbers between (0, 1), and they can sum up to 1. The criteria definition can be manual, but also a generative LLM can be used to help with defining the criteria based on position description. A weight definition for each of the criteria can be manual or automated. After labeling is finished, created labels are compared to the similarity of job and candidate embeddings that the model created for the respective documents, and evaluation metrics are calculated. Metrics used can include NDCG@K, MAP@K and modified version of F1-score. Details about these metrics are described below in connection with evaluation of the trained models.

The evaluation score is assessed at determination step 542. If the evaluation score is satisfied, the position is labeled as learned at step 544 and the processing ends. If the evaluation score is not satisfied, processing continues to check the quality of the job description for the position at step 546, for example, to determine if enough information or information of desirable types is included for analysis with candidate data. The process proceeds to determination step 548 where the job description quality is assessed. If the job description is adequate, processing continues to process step 550, described in more detail below. If the job description is not adequate, the process proceeds to step 552 where the description may be updated with a specialized large language model that has been previously trained on position descriptions. Processing may continue in a loop until either the evaluation score exceeds the threshold or the job description is good enough for processing by the Training Process.

When processing continues to the Training Process at step 550, the model may be trained on all data and new annotations, including information on positions, information on candidates, and information on suitability of candidates for positions (the labels from labeling step). Training may be performed with use of in-house training framework (e.g., written in PyTorch). The framework may use a custom version of Contrastive Loss function. The framework may also use a custom training scheme that allows the system to optimally sample negative observations for the training. The AI models are trained to encode candidates and jobs in shared n-dimensional embedding space, where embeddings of candidates and jobs are comparable. Relevant candidates may, therefore, appear most similar to the jobs for which they are best suited.

To help with memory overhead related to training such big models, a modified version of the solution from “Scaling Deep Contrastive Learning Batch Size under Memory Limited Setup” by Gao et al. is introduced, which allows training such big models with relatively big batch sizes, and complex loss functions. Additionally, thanks to the custom-made architecture of Transformer-based AI matching models and modified pre-training scheme from “Unsupervised Corpus Aware Language Model Pre-training for Dense Passage Retrieval” by Gao et al., adapted specifically for the purpose of pre-training custom-versions of Transformer-based models on the matching task, the models work efficiently on the entirety of the text data without the limits of typical Transformer-based models, which can process only limited number of tokens from one document.

All the above combined allows for training the model to encode jobs and candidates into embeddings, which allow efficient comparison between candidates and jobs beyond keywords and buzzwords, and to represent abstract concepts, like tone, profile of the candidate, synonyms, etc. Because the same shared embedding space is reused across multiple downstream services (e.g., recommendation, career path suggestion), the system avoids maintaining separate redundant models and embedding tables, which reduces persistent storage requirements and amount of separate model deployments.

The evaluation may be performed on every step of the training, and during training the best performing checkpoint of the model is selected based on validation holdout dataset. Then, after the training, the model is evaluated on the Test part of the dataset, to determine if the model has learned the job properly. Evaluation is performed with use of appropriate performance metrics which best reflect the two-fold nature of the task of matching. So for example, there ranking quality metrics can be used: NDCG@K and MAP@K (Normalized Discounted Cumulative Gain, and Mean Average Precision at K, where K can be equal to 10), in conjunction with classification quality metrics - F1-score, or modified version of it defined as harmonic mean of true positive and true negative rate.

When using two types of metrics, the model recommends the best candidates first, but also assigns correct indicators of 'HOT'/'WARM'/'COLD' to them. In some instances, the mean of these scores may be calculated to obtain a final decision if the model has learned the job. In some instances, one of the metrics is used as a main indicator, as some metrics may be saturated more easily than the others. If the threshold is satisfied at determination step 554, processing continues to label the job as learned at step 556, and then to the Improved Model Deployment Process at step 558.

If the evaluation threshold is not satisfied at determination step 554, the Data Engine provides a set of functionalities for efficient error analysis at step 560. The objective is to find observations which are problematic for the model (i.e., most common mistakes it makes). The functionalities include displaying the biggest errors the model has made (i.e., candidates with low label, but who were scored as very similar to the job), and exploring them in detail (i.e., checking how many observations like the one that the error was made on are present in the training data). If not enough training data is present, the Data Engine also provides functionality to collect most similar candidates to the problematic one at step 562 in order to allow the model to train such information properly.

In some cases, new training data can also be added manually at step 564 (e.g., if there are observations found outside of the Data Engine process, which could help with the model’s training). Using all these functionalities, and the same method of sampling new data as previously discussed, new data is obtained, labeled at step 566, added to the training, validation, and testing datasets, and returned to the training step 550, continuing through the loop until the evaluation score is satisfied. Additionally, it is possible to manually supplement additional training observations if some are identified outside of the Data Engine.

Processing then moves to the Improved Model Deployment Process at step 558. As an initial step, the model and model data are evaluated via an automated bias test. Applying the automated bias test before new model deployment prevents any opportunity of deploying a model that displays racial, gender, or any other currently tested bias. The bias test consists of assigning bias-sensitive group indicators to each of the candidates under the newly taught job, and calculating statistics related to differences in assigned badges between the groups. Next, an appropriate statistical test is performed on obtained groups to compare if differences of badge distribution between groups is statistically significant or not. If they are, the model is stopped from being deployed, and the training data itself is analyzed and altered to include a diverse enough sample to prevent bias from occurring. This step is repeated until the newly taught model is not biased.

Processing then continues to step 568 to simulate production deployment and check quality of the final model via actual recommendations on the entirety of customers’ production data, and statistics associated with it (i.e., mean counts of HOT/WARM/COLD badges for each of the job in top 500 recommendations). If the model requires no further modification at determination step 570 (e.g., the badge counts relating candidates to jobs satisfy defined criteria), the model is deployed at step 572. If the model requires further modification, model generation and evaluation criteria may be updated at step 574 (e.g., the training label thresholds for the badges may be raised or otherwise modified) and processing returns to the active learning processing block at step 550. The automated bias testing and deployment gating process is executed using precomputed embeddings and labels, enabling repeated fairness checks with low computational overhead and ensuring that only models meeting bias constraints are loaded into memory on production-serving hardware.

In some embodiments, the system may include an intelligent human language search-to-filter mechanism. The intelligent mechanism is designed to translate human language prompts into an automated filtering process for a search platform, for example, based on models generated as described herein. A typical ATS system may include filters on numerous (e.g., a dozen or dozens) of parameters targeted towards individual parsed characteristics. Not only is the use of such filters tedious, unpredictable, and a source of potential bias, but the management and storage of structured information necessary to support such functionality increases memory and processing to store and evaluate according to the criteria. Further, the GUIs or other interfaces provided by users are often crowded, difficult to learn and comprehend, and nested in manners that are not user-friendly. The human language search-to-filter mechanism eliminates the need for users to manually adjust filter sliders by interpreting their natural language queries through the use of Large Language Models (LLMs) and applying the appropriate filters behind the scenes. This innovation is helpful from the user perspective for dealing with complex application screens, i.e. containing many filters, sliders, radio buttons and similar UI elements. The natural language search-to-filter mechanism reduces the number of client–server round trips required to configure filters, and allows for a more interactive experience of the user.

In an embodiment of LLM integration, advanced LLMs are utilized to understand and interpret human language prompts in a manner that not only understands the particular requests, but also places statements and underlying information to be evaluated in context. In this manner, the system is capable of processing complex queries, including those with multiple implied underlying criteria. A single yet sophisticated query, which would represent many minutes of clicking through the filters, would be achievable within seconds by just typing in the required criteria into a textbox or providing the information via a voice interface (e.g., voice-to-text mechanism provided by the system accommodated for a handicapped user). Very often, an end user of the candidate sourcing feature has specific requirements when looking for talent in the pool of candidates, which are sometimes hard to anticipate. An example of this is the need to show only resumes of people having a particular type of background within their work experience, e.g., startup experience, or working in global multinational companies.

The human language search-to-filter mechanism translates the interpreted search intent into specific filter settings, and in this manner, can understand the product and what filters are used underneath. The filters may be applied invisibly, presenting users with the most relevant search results without manual intervention. In this manner, an interface is user friendly, simplifying the search experience by reducing the need for technical understanding of filter mechanisms and saving users substantial time by providing a more intuitive and efficient search process. From the user experience and user interface perspective, researching such a solution is an advancement in discussion around the necessity of the human interface devices (HID) like keyboard and mouse.

Further, the manner of application of the human language search-to-filter mechanism may itself be customized and/or trained, based on a user providing specific commands or by evaluating user indication of satisfaction with surfaced results. Moreover, the natural language search allows filters to run which would be hard or even impossible to accomplish when defining them manually using user interface components. An example of such search is using high-level terminology - which encompasses multiple possible values at once – that is, terms like “Fortune 500 companies” or “Ivy-league universities”. Instead of clicking out a lengthy list of such companies and universities, the natural language search solution can fill-in them automatically. Accordingly, the human language search-to-filter mechanism can be customized based on the specific needs of different products or platforms, ensuring high accuracy and relevance in diverse application contexts. Cases of such software products are: recruitment tools (in example, recruiters can specify exactly what kind of the candidate they wish to filter out from the candidate pool), e-commerce platforms (shoppers can find products quickly by describing their needs in natural language, e.g.: "I need a red dress for a wedding in size M"), job portals (job seekers can specify their requirements, e.g.: "Looking for remote software engineering jobs with a salary above $100,000"), real estate websites (potential buyers or renters can describe their ideal home, e.g.: "3-bedroom house with a garden in downtown area under $500,000"), and travel booking websites (travelers can outline their preferences, e.g.: "Family-friendly hotels in Paris with a pool and free breakfast”).

In an embodiment, a user inputs a search query in natural language and the system processes this input using an LLM to extract key terms and criteria. The extracted criteria are mapped to specific filters available on the platform, and the system adjusts these filters invisibly, setting the parameters according to the interpreted query. It is possible to show on the UI/UX components values set from the corresponding filter (assuming the actual filter is included in the design of the page). Those search results then are displayed to the user, reflecting the automatically applied filters. Users can refine the results further if needed, with the system continuously adapting to new inputs. By reducing the need for manual filtering, the mechanism makes searching faster and more intuitive. Users can find what they are looking for more quickly, leading to higher satisfaction and engagement. Finally, the user has an option to choose to use the traditional manual filtering mechanism if she/he wishes to do so. The technology can be adapted for various industries and types of search platforms, making it highly versatile.

This innovative mechanism leverages large language models to transform human language prompts into an automated, invisible filtering process. It represents a significant advancement in user interface design, offering a more natural and efficient way for users to interact with search platforms. By simplifying the search process and enhancing the accuracy of results, this technology has the potential to significantly improve user experiences across a wide range of applications. This mechanism utilizes the generative capabilities of the large language models. It also has the general wide capability to understand the context of the data based on general human knowledge.

In the process of utilizing the human language prompt from the user, the context of the input is extracted and passed on for further processing, to elicit a couple of feature deliverables. Such data derived from the context of the prompt is used to do re-ranking of the candidates on the view over candidate pool. This is possible due to data augmentation on the ranking and matching part, using parts of the text holding the actual context, the system can modify the job description to hold more data on the user requirements. In the result, the user can control the ranking of the candidates by specifying exactly his/her needs when it comes to candidate selection using the natural language input.

In an embodiment of the present disclosure, use of the complex models and data processing systems described herein may also be used on an ongoing basis to provide career path recommendations at multiple levels of abstraction (e.g., from recommendations for specific day-to-day actions and activities to long-term strategic career choices). For example, based on the non-soft skills of the candidate (user) (e.g., technical skills, tools and knowledge), actions can be recommended in accordance with multiple career development strategies, such as typical career paths and alternative career paths. Typical career paths may include paths that are the most natural choice according to training, education, and job history, e.g., a person with knowledge of graphic design computer programs receives Graphics Design, UX Design, etc. as recommendations. Alternative career paths include less obvious paths in areas that require related skills or specific additional skills that can be learned, e.g., ‘Data Science path’ for a business analyst or ‘Blockchain Engineering’ for a software developer.

In one example of the recommendation system, in a first step skills are extracted from available data (e.g., CVs, etc.) using a simple text-matching technique with a carefully prepared skills database underneath, and then, treating the extracted information as coherent sets of skills, the Skill2Vec model (based on Word2Vec, described for example in “Skill2vec: Machine Learning Approach for Determining the Relevant Skills from Job Description,” by Van-Duyet et al., published October 9, 2019) is trained to be able to represent the skills by embeddings. Note that not all skills from the database appear in our data, so some skills will not have embeddings. This situation, however, is not problematic and should not happen too often because we assume that, firstly, the people for whom we will recommend career paths are similar to the data we have used to train the model (they work in similar industries and have similar skills); secondly, rare and poorly represented skills will not be crucial and dominant in the recommendation process, and therefore can be omitted.

To define possible career paths, data regarding standardized career information (e.g., https://www.onetonline.org/find/career) may be used, where career pages are available along with their categorization, as well as a career description and its responsibilities. Using the skills parser, skills are extracted from the career descriptions, and a subset (e.g., the top 20) are selected for each based on the tf-idf metric to create a career-to-skill mapping. This mapping may be automatically and/or manually checked, with rankings utilized to provide feedback and optimize associations. In this manner, some careers are deleted/merged to ensure the best quality (e.g., in a situation where there aren’t enough skills in a given field in our data to define a career well, or careers are too similar to distinguish them only based on skills, like “Special Education Teachers, Kindergarten” and “Special Education Teachers, Preschool”). The careers may also be renamed based on some rules and manual changes, for example “Data Scientists” → “Data Science”, “Software Developers” → “Software Development”, to indicate careers rather than job titles.

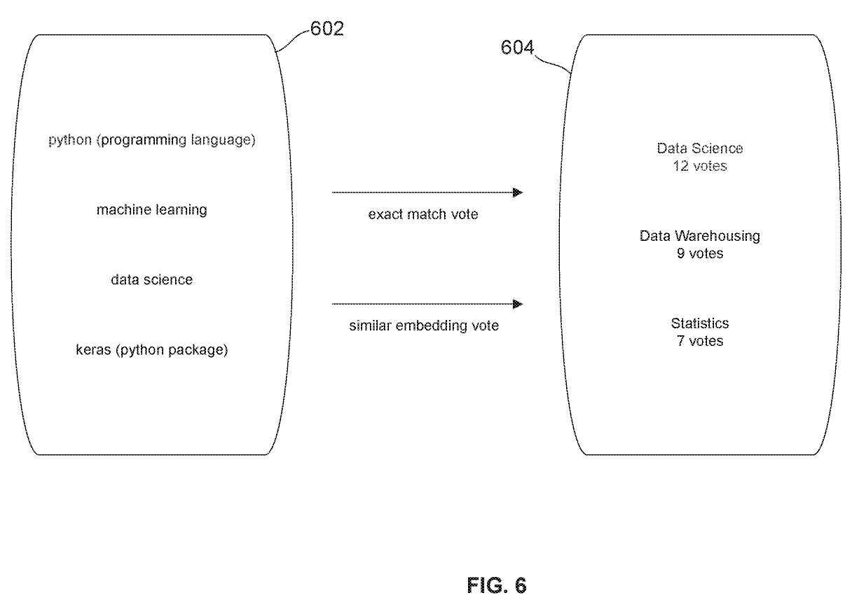

With additional reference to FIG. 6, in order to match user’s skills to careers a comparison is performed, such as by comparing two sets of vectors – (1) a set of user skill embeddings 602 and (2) a set of skill embeddings 604 for a given career. Some approaches may include simplifying the representation to mean embedding or comparing everyone with everyone, which may oversimplify the comparison. For example, such a comparison may not take into account the duality of some careers (e.g., chemistry teachers have skills from two groups - related to chemistry and related to teaching) and may, therefore, not give good results. The disclosed embodiments are based on “skills voting,” whereby a list of the user’s non-soft skills serves as the query, such as is depicted in FIG. 6. As an example of query processing, for each skill in the list, an exact match vote is performed to identify the careers that contain this exact skill and give them a weighting of votes (e.g., 2 votes). A similar “embedding vote” is also performed if the number of careers from exact match vote is less than some threshold (e.g., 3), where a set vote weighting (e.g., 1 vote, usually lower than the exact match vote weight) is added to the number of careers from step 1 careers that are the most similar in the embedding space. This output is then evaluated, such as returning a number of careers with the highest number of votes as typical career paths.

In an example, the distance between a skill and a career is defined as follows: calculate the distances between the given skill (its embedding specifically) and all the skills from a career (e.g., 20 distances), taking 10 (parameter) lowest distances and calculate their average - this value is the distance between the skill and career. This way of measuring distance takes into account that careers can consist of skills from different domains. Obtaining the ranking of alternative career paths is done by applying the same algorithm, with the change in the 1st step, that the sum of sets of skills from a number (e.g., 3) typical careers is used as the query.

The foregoing is merely illustrative of the principles of this disclosure and various modifications may be made by those skilled in the art without departing from the scope of this disclosure. The embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein may be modified or varied to optimize the systems, devices, apparatuses, components, and methods. Moreover, it will be understood that the systems, devices, apparatuses, components, and methods may have many applications. The disclosed subject matter should not be limited to any single embodiment described herein, but rather should be construed according to the claims.

What is claimed is:

1. A method of synchronizing complex data sets over disparate domains, comprising:
identifying a change of information at an aggregated data processing system;
creating a message representing the change of information in a standardized format of the aggregated data processing system;
identifying a plurality of unique client system types to receive the change of information;
determining, for each unique client system type, whether a standard data type of the change of information corresponds to a respective client system data type of the unique client system type; and
creating, for each unique client system type where the standard data type matches the respective client system data type, a message compatible with a respective API service of the unique client system.

2. The method of claim 1, further comprising modifying, for each unique client system type where the standard data type does not match the respective client system data type, the standard data type to map to the respective client system data type.

3. A method of training a complex data aggregation system, comprising:
receiving information associating first data for a first category of information data with second data of a second category of information;
determining whether the second data corresponds to preexisting data within the second category of information;
based on the second data not corresponding to the preexisting data, labeling data records within the second data;
based on the labeling of the second data, creating additional preexisting data based on multiple records of the second data; and
training a machine learning model to evaluate data of the first category versus the additional preexisting data.

4. The method of claim 3, wherein the first category of information comprises candidate information and wherein the second category of information comprises job information.

5. The method of claim 4, wherein the information associating the first data with the second data comprises a shortlist, automated feedback regarding a suitability of a candidate and a job, or direct client feedback regarding the suitability of the candidate for the job.

6. The method of claim 3, wherein determining whether the second data corresponds to preexisting data within the second category of information comprises comparing the second data with preexisting data for third data of the second category of information.

7. The method of claim 6, further comprising creating a negative mapping between the second data and additional data of the preexisting data of the second category of information.

8. The method of claim 3, wherein labeling data records is based on similarities of the second data with the multiple records of the second data.

9. The method of claim 8, further comprising:
evaluating a quality of the second data and the multiple records of the second data;
determining that the quality does not meet a threshold quality; and
based on the quality not meeting the threshold quality, supplementing the second data and the multiple records of the second data with an output from a generative large language model.

10. The method of claim 9, wherein the generative large language model has been trained based on the second category of information.

11. The method of claim 3, further comprising:
evaluating a quality of the machine learning model; and
determining that the quality does not meet a threshold quality; and
based on the quality not meeting the threshold quality, supplementing a training data set for the machine learning model with additional data similar to the second data.

12. The method of claim 3, further comprising evaluating the machine learning model based on a bias test.

13. The method of claim 12, further comprising determining that the machine learning model fails a bias test and modifying a criterion for generating the machine learning model based on the machine learning model failing the bias test.

14. A method of training a machine learning model within an aggregated data processing system, comprising:
receiving information associating first data for a first category of information with second data for a second category of information;
determining that the second data does not correspond to preexisting data within the second category of information stored in an aggregated data repository;
based on the second data not corresponding to the preexisting data, labeling a plurality of records within the second data;
generating, from the labeled plurality of records, an updated representation for the second category of information comprising aggregated data derived from multiple records of the second data; and
training the machine learning model using the aggregated data and the first data by encoding the aggregated data and the first data into a shared embedding representation and updating parameters of the machine learning model based on comparisons between the embedding representations.

15. The method of claim 14, wherein the first category of information comprises candidate information and the second category of information comprises job information.

16. The method of claim 15, wherein the information associating the first data with the second data comprises at least one of: a shortlist, automated feedback regarding a suitability of a candidate for a job, or direct client feedback regarding the suitability of the candidate for the job.

17. The method of claim 14, wherein determining that the second data does not correspond to preexisting data within the second category of information comprises comparing the second data with preexisting representations of additional data of the second category of information, and further comprising creating a negative mapping between the second data and the additional data based on dissimilarity between the representations.

18. The method of claim 14, wherein labeling the plurality of records is based on similarity relationships among records of the second data, and further comprising evaluating a quality of the plurality of records and, responsive to the quality not meeting a threshold, supplementing the plurality of records with output from a generative large language model.

19. The method of claim 18, wherein the generative large language model has been trained based on data representative of the second category of information.

20. The method of claim 14, further comprising evaluating the machine learning model using performance metrics derived from the shared embedding representation and, responsive to the performance metrics not meeting a threshold, supplementing training data with data similar to the second data, and further comprising performing a bias test and modifying a criterion used to generate the machine learning model responsive to determining that the machine learning model fails the bias test.
